(19) United States
(12) Patent Application Publication
(10) Pub. No.: US 2006/0287919 A1
(43) Pub. Date: Dec. 21, 2006

(54) Advertising search system and method

(75) Inventors: Sean L. Rubens, Lafayette, CO (US); David L. Thomas, Boulder, CO (US)

Correspondence Address: TOLER SCHAFFER, LLP, 5000 PLAZA ON THE LAKES, SUITE 265, AUSTIN, TX, 78746, US

(73) Assignee: Blue Mustard LLC, Boulder, CO (US)

(21) Appl. No.: 11/443,931

(22) Filed: May 31, 2006

Related U.S. Application Data
(60) Provisional application No. 60/686,993, filed on Jun. 2, 2005.

(51) Int. Cl. G06Q 30/00; G06F 17/30

(52) U.S. Cl. 705/14; 707/3; 707/104.1

(57) ABSTRACT

Systems, methods and computer-readable media for searching advertisements are disclosed. Methods of searching advertisements include displaying a search interface to a user, receiving search data from the user, via the search interface, to request a search directed to advertising information and displaying search results related to the search directed to advertising information to the user. The search results include information related to advertisements that are relevant to the received search data.

### CROSS-REFERENCE TO RELATED APPLICATION(S)

This application is a non-provisional of and claims priority from U.S. Provisional Patent Application No. 60/686,993 to inventors Sean L. Rubens and David L. Thomas filed on Jun. 2, 2005 and entitled “CROSS-MEDIA ADVERTISING SEARCH ENGINE,” which is incorporated herein by reference in its entirety.

### COPYRIGHT NOTICE

A portion of the disclosure of this patent document contains material which is subject to (copyright or mask work) protection. The (copyright or mask work) owner has no objection to the facsimile reproduction by anyone of the patent document or the patent disclosure, as it appears in the Patent and Trademark Office patent file or records, but otherwise reserves all (copyright or mask work) rights whatsoever. Copyright© 2005.

### BACKGROUND

1. Field

Embodiments of the present invention generally relate to search engines and advertising.

2. Description of the Related Art

Internet advertising is typically provided on e-commerce web sites or web sites that focus on delivery of news, information or other entertainment content, such as web sites or portals including Yahoo!® and the MSN® network of Internet services and search engines like Google®. No search portal has a primary purpose of allowing advertising content to be searched nor does any search portal provide for the searching of multiple forms of advertising content.

### SUMMARY

Methods, systems and computer readable media for searching advertisements are disclosed. Embodiments presented herein generally include displaying a search interface to a user, receiving search data from the user, via the search interface, to request a search directed to advertising information, and displaying search results related to the search directed to advertising information to the user. In certain embodiments, the search data may include user preference settings, historical search information, and/or information about the user's location.

The search results retrieve information related to advertisements that are relevant to the received search data. The advertisements included in the search results may be from a plurality of different types of advertising media. The advertisements in the search results may be displayed in order of relevance of the advertisements to the search data.

In certain embodiments, a landing site link may also be displayed to the user. In such embodiments, the landing site link may include information sufficient to direct a user interface to an advertiser landing site associated with a selected advertisement.

Embodiments disclosed herein also include receiving a user selection of an advertisement from the search results, and displaying advertising content of the selected advertisement to the user.

### BRIEF DESCRIPTION OF THE DRAWINGS

The present disclosure may be better understood, and its numerous features and advantages made apparent to those skilled in the art by referencing the accompanying drawings.

FIG. 1 is block diagram of an exemplary embodiment of a computer system.

FIG. 2 is a diagram of an exemplary embodiment of an advertising search portal system.

FIG. 3 is a general diagram of an exemplary embodiment of an advertising search page display.

FIG. 4 is a general diagram of an exemplary embodiment of an advertising search results display.

FIG. 5 is a general diagram of an exemplary embodiment of an advertising search options display.

FIG. 6 is a flow diagram of an embodiment of a cross media advertising retrieval process.

FIG. 7 is a general diagram of an exemplary embodiment of an advertising search results display including search options.

### DESCRIPTION OF THE DRAWINGS

Methods and systems are described for delivering cross-media advertising content to end users of a web search portal based upon keyword searches initiated by the end users. According to one embodiment, an ad search portal includes advertising content across multiple media types, including combinations of the following: television commercial ads, radio ad spots, magazine, catalog and newspaper print ads and web or Internet ads. In one embodiment, a search initiated by a user results in the simultaneous delivery of all forms of advertising content meeting the keyword search without any other form of news information or other entertainment content.

In the following description, numerous specific details are set forth in order to provide a thorough understanding of embodiments of the present invention. It will be apparent, however, to one skilled in the art that embodiments of the present invention may be practiced without some of these specific details. In other instances, well-known structures and devices are shown in block diagram form.

Embodiments of the present invention include various steps, which will be described below. The steps may be performed by hardware components or may be embodied in machine-executable instructions, which may be used to cause a general-purpose or special-purpose processor programmed with the instructions to perform the steps. Alternatively, the steps may be performed by a combination of hardware, software and/or firmware.

Embodiments of the present invention may be provided as a computer program product, which may include a machine-readable medium having stored thereon instructions, which may be used to program a computer (or other electronic devices) to perform a process. The machine-readable medium may include, but is not limited to, floppy diskettes, optical disks, compact disc read-only memories (CD-ROMs), and magneto-optical disks, ROMs, random access memories (RAMs), erasable programmable read-only memories (EPROMs), electrically erasable programmable read-only memories (EEPROMs), magnetic or optical cards, flash memory, or other type of media/machine-readable medium suitable for storing electronic instructions. Moreover, embodiments of the present invention may also be downloaded as a computer program product, wherein the program may be transferred from a remote computer to a requesting computer by way of data signals embodied in a carrier wave or other propagation medium via a communication link (e.g., a modem or network connection).

While, for convenience, embodiments of the present invention are described with reference to an advertising search portal that is separate and independent of existing content search portals and dedicated to searching and delivering of cross-media advertising content, other embodiments of the present invention are equally applicable to various other operational models. For example, the ad search portal described herein may be integrated with or form part of a larger search engine, web site or portal. Indeed, it is contemplated that embodiments of the present invention may be locally hosted and implemented as a tab on one or more of the Yahoo!, Google, or MSN web sites. Alternatively, the ad search portal may operate in accordance with an Application Service Provider (ASP)-type model by responding to keyword search requests for ad content provided by intermediary web sites, which directly interact with end users.

Terminology

Brief definitions of terms used throughout this application are given below.

The phrase “cross-media advertising content” generally refers to advertising content spanning two or more media types, such as television, video, audio, print image or photo, web banners, multimedia formats, etc. In one embodiment, search results provided in response to a keyword search include links to a minimum four categories of advertising, including television/audio, print/catalog, radio/audio and web advertisements.

The terms “connected” or “coupled” and related terms are used in an operational sense and are not necessarily limited to a direct connection or coupling.

The phrases “in one embodiment,” “according to one embodiment,” and the like generally mean the particular feature, structure, or characteristic following the phrase is included in at least one embodiment of the present invention, and may be included in more than one embodiment of the present invention. Importantly, such phases do not necessarily refer to the same embodiment.

If the specification states a component or feature “may”, “can”, “could”, or “might” be included or have a characteristic, that particular component or feature is not required to be included or have the characteristic.

The term “responsive” includes completely or partially responsive.

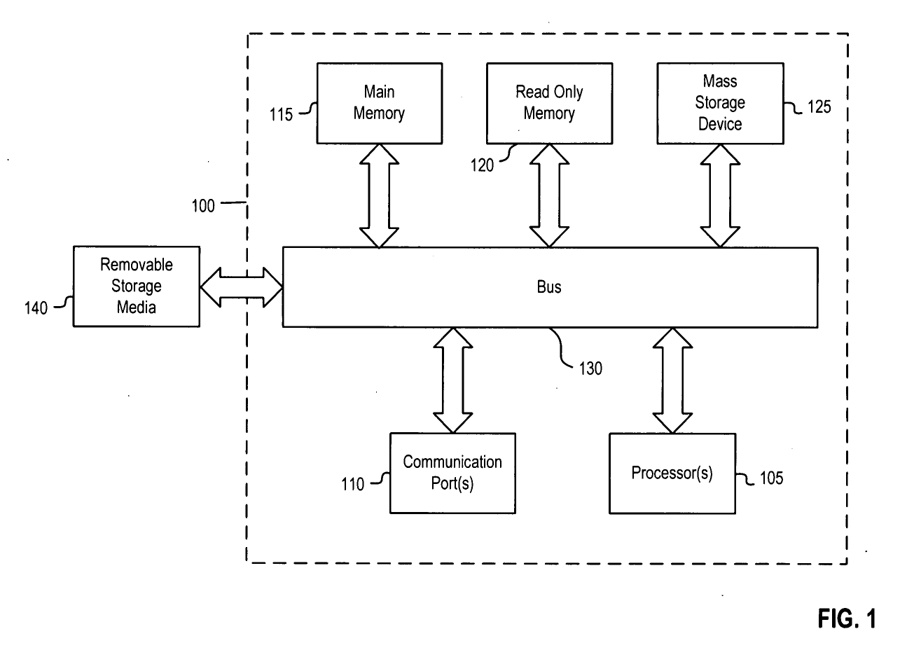

An exemplary computer system 100, representing an exemplary server, with which various features of the present invention may be utilized, will now be described with reference to FIG. 1. In this simplified example, the computer system 100 comprises a bus 130 or other communication means for communicating data and control information, and one or more processors 105, such as Intel® Itanium® or Itanium 2 processors, coupled with bus 130.

Computer system 100 further comprises a random access memory (RAM) or other dynamic storage device (referred to as main memory 115), coupled to bus 130 for storing information and instructions to be executed by processors 105. Main memory 115 also may be used for storing temporary variables or other intermediate information during execution of instructions by processor(s) 115. Computer system 100 also comprises a read only memory (ROM) 120 and/or other static storage device coupled to bus 130 for storing static information and instructions for processors) 105.

A mass storage device 125, such as a magnetic disk or optical disc and its corresponding drive, may also be coupled to bus 130 for storing information and instructions.

One or more communication ports 110 may also be coupled to bus 130 for supporting network connections and communication of information to/from the computer system 100 by way of a Local Area Network (LAN), Wide Area Network (WAN), the Internet, or the public switched telephone network (PSTN), for example. The communication ports 110 may include various combinations of well-known interfaces, such as one or more modems to provide dial up capability, one or more 10/100 Ethernet ports, one or more Gigabit Ethernet ports (fiber and/or copper), or other well-known network interfaces commonly used in current or future internetwork environments. In any event, in this manner, the computer system 100 may be coupled to a number of other network devices, clients, and/or servers via a conventional network infrastructure, such as an enterprise's Intranet and/or the Internet, for example.

Optionally, operator and administrative interfaces (not shown), such as a display, keyboard, and a cursor control device, may also be coupled to bus 130 to support direct operator interaction with computer system 100. Other operator and administrative interfaces can be provided through network connections connected through communication ports 110.

Finally, removable storage media 140, such as one or more external or removable hard drives, tapes, floppy disks, magneto-optical discs, compact disk-read-only memories (CD-ROMs), compact disk writable memories (CD-R, CD-RW), digital versatile discs or digital video discs (DVDs) (e.g., DVD-ROMs and DVD+RW), Zip disks, or USB memory devices, e.g., thumb drives or flash cards, may be coupled to bus 130 via corresponding drives, ports or slots.

Systems and methods for searching and delivering cross-media (television, video, audio, print image or photo, web banners, etc.) advertising content to consumers, business users or other end users through a web search portal are provided. According to one embodiment, consumers can search a portal web site by entering keywords and search results will be returned showing relevant search result listings consisting of, containing thumbnails of, providing a list of, or a link to, advertising content associated with the specified keywords. The advertising search results may include one or more of television commercial ads, video ads, short form advertaintment films or sponsored video content, print advertisements from magazines, catalogs or newspapers, radio ads or other forms of audio advertising and/or internet or web ads including but not limited to banner or display ads, animated banner ads, rich media web ads or video-enabled web ads. In one embodiment, the advertising content displayed in or otherwise referenced in the search results are displayed based on a search algorithm that references and correlates advertising content keyword and other metadata maintained in an ad metadata database to determine a listing of relevant ads.

According to one embodiment, search results include at a minimum four categories of advertising, including television/audio, print/catalog, radio/audio and web advertisements. In other embodiments, the end user or requesting service may specifically narrow the media types searched or displayed.

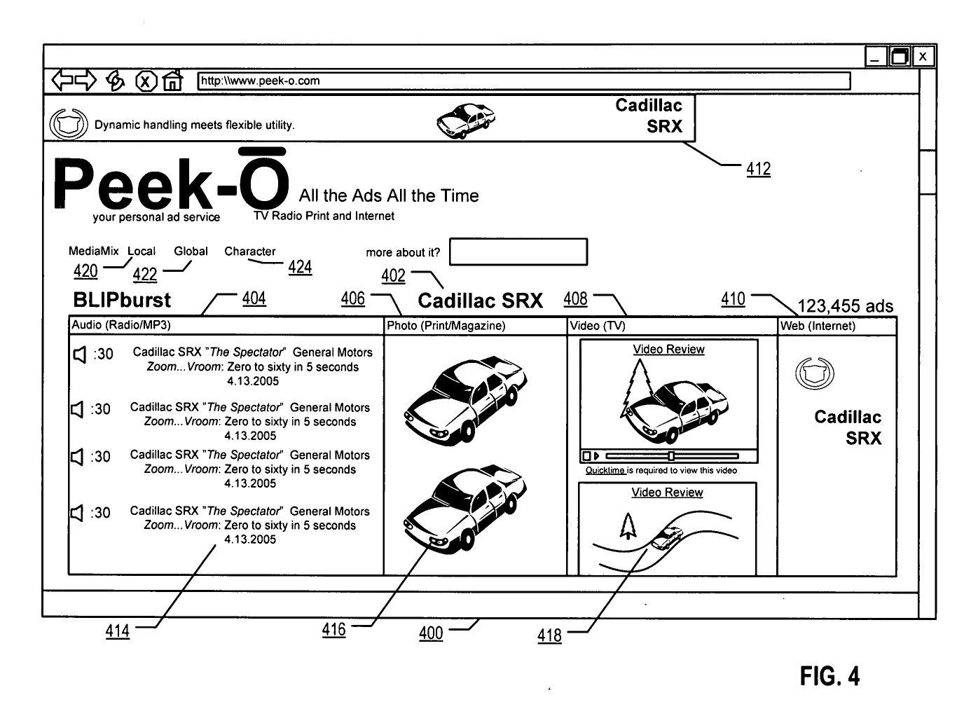

The search results may be displayed with descriptive text (e.g., 414 in FIG. 4) from the advertiser along with a unique image or thumbnail (e.g., 416 in FIG. 4) that represents each ad. Users can view the displayed ads by clicking on them in their web browser which may initiate a full-screen or other view of the selected ad, such as display of the full print or web image or launch of the video or audio ad content file in an appropriate media player software program. After viewing the ad, the end user can click on the image or post-play image for video or audio ads to link directly to an advertiser controlled landing web page or a specific promotional offer or product/service information web page on the advertiser's web site or hosted by the ad search portal and associated with the advertiser. According to one potential revenue model for an ad search portal, advertisers are charged for each end user full-page ad view and/or click-through of their ad after viewing.

In one embodiment, ad search results are presented to the end user based on keyword relevancy and may be prioritized or ordered in some fashion. Various ordering mechanisms may be employed to determine the order of presentation of the ads in the search results listing. For example, the ordering of the ads in the search results listing may be determined by advertiser specified pay-per-click (PPC) (also referred to as cost-per-click (CPC)) or cost-per one thousand impression (CPM) prices, a combination of these pricing units or some other current or future advertising industry accepted pricing unit for each keyword for each ad.

In one embodiment, a real-time auction clearing process is utilized to re-rank the keyword based ad search results according to the bid prices for the specified keywords for each ad. For example, the relevant ads will be ordered from highest to lowest keyword CPC or CPM bid price and displayed accordingly. In this manner, all ad search results will be relevant to the end user-specified keywords, but final search result placement of the relevant ads is determined by advertiser willingness to pay for placement. Under such a model, advertisers are charged for each end user full page ad view and/or click-through of their ad after viewing based on their keyword based CPM and/or CPC bid prices.

Various other ordering mechanisms are contemplated for presenting the search results. For example, specific methods are described below that govern the order of search results listings based on a number of parameters specific to the search as well as publisher and/or advertiser supplied information.

In one embodiment, the search results listings are placed in order based on a combination of the search relevancy index and the publisher or advertiser bid price for either CPM or CPC placement as determined by an auction process for each search keyword. The search results relevancy index is determined by the search engine algorithm which matches specific user supplied keywords to the ad content metadata to determine relevant search results for each search. The higher the value of the search results relevancy index for each content item, then the higher the likelihood of content relevant to the user supplied search keywords. The order of placement of search results may be based on a weighted average of the search relevancy index and the placement bid amount. In one example of this weighted average value method, the search results placement order could be determined by the highest weighted average value according to the following formula: 50% multiplied by search relevancy index value which ranges from 1-10 for each content item plus 50% multiplied by placement bid amount for the content item in dollars, typically $0.25 to $10.00 CPC as determined by the advertiser or publisher. Search results are placed in rank order on the search results page from highest to lowest weighted average value. This weighted average value method combines the content relevancy to the keyword as well as the publisher or advertiser placement bid amount to determine final ad placement within the search results.

In another embodiment, the search results listings are first placed in rank order for placement based on the search relevancy index value. The top ten search result listings based on highest CPC or CPM bid amount for the keyword(s) for each content item are extracted from this listing of relevant results for a specific keyword search. The search results listings that are displayed or placed on the first display page of the search results listing are then determined randomly from the top ten results as determined by highest CPC or CPM bid amounts. A random number generator software program may assign a random number to each of the top ten CPC or CPM search results to be displayed on the first search results display page. The content items are then reordered for final placement on the first display page according to the assigned random number value from highest to lowest value. Placement for content items not displayed on the first page, for example search results listings other than the top ten listings, may be determined according to rank order of the search relevancy index values. In order to determine the top ten listings where there are ties in bid amounts or to break ties in the search relevancy index ranking process, a random number assignment process may be applied to each tied content item. Final placement order or inclusion in the top ten for tied content items may be determined by the highest assigned random number among the tied content items.

According to various embodiments as described herein, the method for displaying advertising content based on end-user supplied keyword interest is deemed an advertising or ad search portal. At least one point of uniqueness of embodiments of the present invention stems from the intent to simultaneously deliver all forms of advertising content meeting a keyword search without any other form of news, information or other entertainment content as delivered by other web sites or portals like Yahoo! or MSN, search engines like Google or by internet ad networks to their member content-related or e-commerce web sites. Another point of uniqueness of embodiments of the present invention stems from the ad search portal's broad delivery of advertising content across multiple media types, including television commercial ads, radio ad spots, magazine, catalog and newspaper print ads and web or internet ads for each search.

While embodiments are described in the context of direct end user interaction with the ad search portal, in alternative embodiments, the entire ad search process may be delivered by electronic means to devices, internet web sites or intranets or networks of devices, web sites or intranets. In such an embodiment, the search keywords may be defined by a system, end user and/or some other mechanism and relevant ad search results may be presented by the ad search portal system to the devices, web sites or intranets or networks of devices, web sites or intranets.

In another embodiment, the ad search by keyword process may be narrowed, extended or refined by end user selectable options that are presented before or along with the relevant ad search results associated with the original keyword search. An example of such end user selectable options in the context of generic keyword searches is described below.

According to one embodiment, such options enable sub-category keyword searches based on a set of additional keywords, concepts, or images that may be presented to the end user and are related to or have an affinity to the original keyword search entered by the end user and/or may be provided within the context of the ad metadata database and offered to the end user. Various methods of identifying sub-category keyword searches are contemplated a few examples of which are described in below.

In an embodiment using sub-category keyword searches, end users are presented with a set of sub-category keywords to refine and advance their search with an additional click. In this manner, the ad search portal offers meaningful and relevant ways in which the end user may narrow, extend or more closely define the ad search process. By selecting one of the sub-category keywords or associated images, the end user is provided with a mechanism to initiate another ad search process with the original and sub-category keywords as part of the search string in the search algorithm.

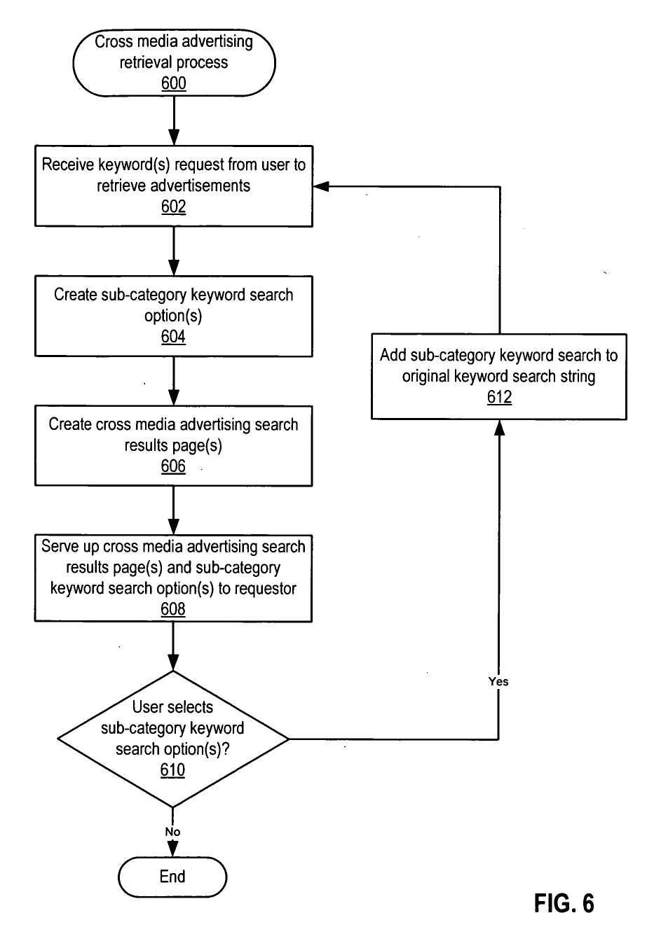

As described in more detail below, FIG. 6 is a flow diagram illustrating an advertising search retrieval process in accordance with one embodiment of the present invention. In the example of FIG. 6, the advertising keyword search and retrieval process includes an optional keyword subcategory search options feature.

In another embodiment, the ad search portal can deliver ads to end users in a targeted manner based on their location or zip code or user-defined opt-in preferences. According to one embodiment for localization, the ad search algorithm resolves the search of the ad metadata database for both keyword(s) and location relevancy. The location relevancy may be determined by correlating the end user's Internet Service Provider (ISP) or other Internet access point to a particular geographic region, zip code or set of zip codes and cross referencing this end user location information against location relevancy information included in the ad metadata database. Various mechanisms are known for approximating end user location with reference to HyperText Transport Protocol (HTTP) requests originated by the end user. In one embodiment, the end user's approximate geographic location is determined by using a well known TCP/IP function called TraceRoute along with the end user's IP Address as captured from its HTTP interactions with the ad search portal system web site to identify the domain name and IP Address of each internet router hop between the end user and the ad search portal web site internet hosting location. The internet router hop information and the end user's IP Address can be cross-referenced against a look-up table that is built and maintained for all Internet Service Providers (ISPs), associated router domain names and IP Addresses and end user assigned IP Address ranges. This lookup table links certain internet router hop IP Addresses, domain names and ISP IP Address ranges to physical network geographical regions or general locations. In this manner, the end user's network route, as provided by the TraceRoute command, can be utilized to determine the location of the last router hop before the TCP/IP traffic is delivered to the end user by the ISP over the local telecommunications network. The physical location of this last router hop, as defined in the lookup table, can be used to infer the approximate geographic location (region, state, city or metro area) of the end user. In this manner ad search results will be keyword and location relevant.

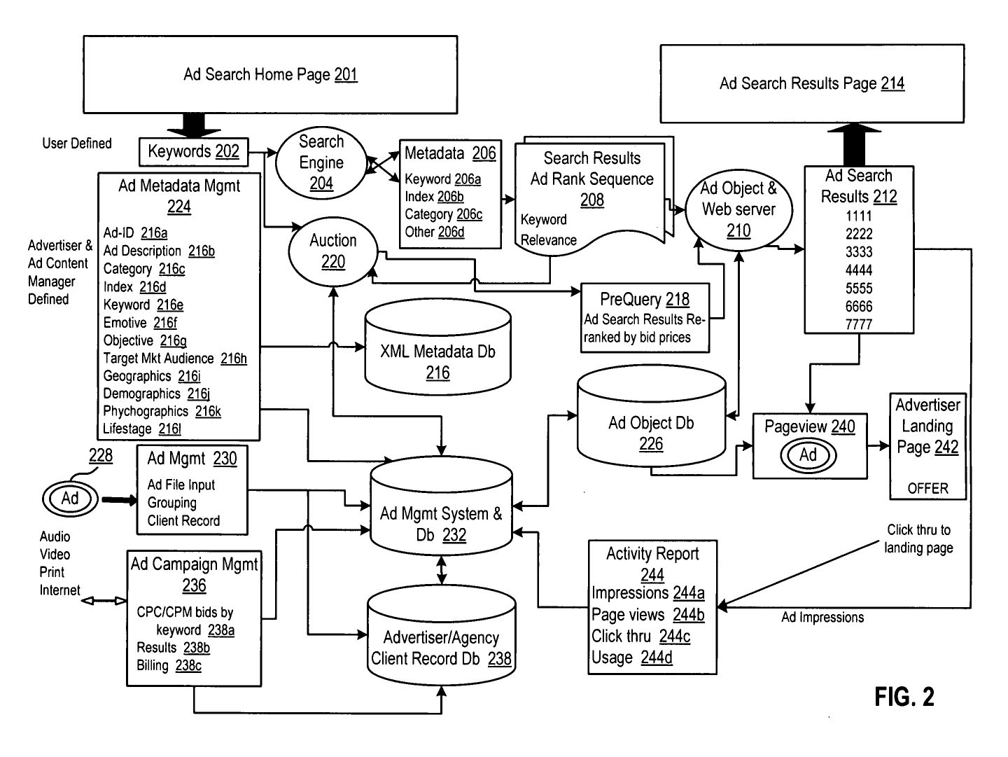

In one embodiment, for end user preference targeting, the end user may opt to provide preference information on the portal web site or in some other manner to define user specific market segmentation, interest categories, demographic and/or psychographic information. This user preference data may then be captured in a user preference metadata database. When the preference-enabled end user performs an ad search on the portal web site, the search engine algorithm may perform keyword relevancy, location relevancy and user-preference relevancy searches of the ad metadata database. For example, in an embodiment using the system architecture depicted in FIG. 2, the user preference profile is pulled from a user preference database and referenced against the user preference or targeting metadata contained in the ad metadata database to determine the set of ads in the ad database that most closely meet the keyword search, location and user preference relevancy requirements. The listing of most relevant ads may then be prioritized for presentation to the end user based on other criteria as described earlier. For example, the ad search results may be re-ranked based on the advertiser's keyword CPC or CPM bid prices to determine ad placement in the targeted search results listing. Again, depending upon the particular revenue model, advertisers may be charged for each end user full page ad view and/or click-through of their ad after viewing based on their keyword based CPC and/or CPM bid prices plus a fixed percentage or multiplier or some other premium pricing method to reflect the increased value to advertisers of the ad targeting by end user preferences.

FIG. 2 illustrates a high-level system architecture that may be used to operate an advertising search portal web site over the Internet in accordance with one embodiment of the present invention. The exemplary system architecture depicted in FIG. 2 is only one of many possible representations and implementations. For example, in FIG. 2, some of the databases or application functions may be combined or further distributed in actual system implementations. Further, for sake of simplicity, the user preference targeting application, database and process and the administrative database and application are not shown in FIG. 2.

According to one embodiment, the ad database 226 is an object database containing the ad image, audio and video files, which may be indexed by a unique ad identifier. The ad database 226 may also include an advertiser display image, post-play display image for audio and video ads and landing page uniform resource locator (URL) information for each ad.

In one embodiment, the ad metadata database 216 is implemented as an eXtensible Markup Language (XML) database containing the metadata associated with each unique ad as identified by its unique ad identifier, for example. The metadata may include, but is not necessarily limited to, information about each ad stored in the ad database 226 including industry-standard Ad-ID metadata elements 216a, descriptions 216b of the ad based on its audio, text and image content, conversion to text keywords, advertiser-supplied keyword associations 216e, industry, product or service category 216c and subcategory assignments index 216d, emotive response 216f, objective segment 216g, life stage 216l, the purpose or intention of the ad—for example branding, product sales, promotion, public service, political, etc., location relevancy metadata 216i, target markets, target customers or audience 216h, target demographics 216j, psychographics 216k, etc. Preferably, the ad metadata construct identifies and captures the who, what, when, where, how and why of each ad. According to one embodiment, the advertiser provides this information via an ad metadata management interface 224 when the ad 228 is entered into the ad database 226. Alternatively, ads may be manually or automatically classified by the ad search portal employees or algorithms associated with the search portal.

In one embodiment, an ad campaign management database 236 allows the advertiser to specify and refine keywords and metadata for each ad and manage their ad campaign on the ad search portal. The advertiser may assign CPC or CPM bid prices 238a to each keyword for each ad or grouping of ads, actively manage their ad campaign bidding strategy, view ad placement results 238b, view ad performance such as impressions, page views and click-through rates and view their billing information 238c.

According to one embodiment, an end user preference database is provided to manage and organize end user preference information. The end user preference database stores end user preference information for each opt-in end user that elects to provide such information. In this manner, such end user may receive more targeted ads when using the ad search portal. The end user preference database is accessed when preference-enabled end users conduct ad searches on the web portal and the metadata information extracted from it is utilized by the ad search engine to resolve user-preference relevancy of ad search results in addition to keyword relevancy and location relevancy. The end user preference database allows the ad search results to be targeted to each end user's specified preferences.

The ad search engine algorithm may utilize user-supplied information, including keywords 202, implied or explicit location and/or user preferences to determine which ads in the ad database 226 are most relevant to each end user's ad search. The search engine 204 may be implemented as a custom search engine or may leverage existing or future search engine technologies. According to one embodiment, the search engine 204 is configured to cross reference keywords from search data 202 against ad keyword metadata 206a, index metadata 206b, category metadata 206c, and/or other metadata 206d, such as location metadata, targeting and/or preference metadata in the ad metadata database 216 supplied by advertisers, for example, to determine an ad relevancy index and determine the listing of ads that may be returned within the ad search results listing.

In one embodiment, an ad management system is provided. The ad management system provides the advertiser with the ability to enter an ad 228 into the ad database 226 through an ad management interface 230, assign metadata information 206 about the ad which is entered into the ad metadata database 216 through an ad metadata management interface 224 and/or perform ad campaign management and administrative tasks relating to the ad content to be utilized by the ad search portal through ad campaign management interface 236.

According to one embodiment, an auction management system 220 conducts a real time auction for each set of keywords by receiving the relevant ad search listing results 208 from the ad search engine 204, accessing the advertiser keyword CPC and/or CPM bid prices 238a from the ad management system and re-ranking the relevant listings into final ad search placement order 218 based on the highest to lowest CPC and/or CPM bid prices.

According to one embodiment, the web server 210 and user interface systems provide the end user with the ad search portal web pages 201, 214, content and interactive experience, deliver keywords, location and end user identification information to the ad search engine 204 to initiate an ad search and serve the ad search results 212 and any resulting page view 240 or click-through web pages (i.e., landing page 242) to the end user.

In an embodiment employing search tracking, the search tracking application 244 may track one or more of search sessions 244d, keyword instances, displayed ad impressions 244a, end user page views 244b and end user click-through 244c from ads to advertiser controlled landing web pages 242. This information may be tracked and logged for each search session and relayed to the search portal administrative system 232 and the ad management system.

In the example of FIG. 2, the ad search portal administrative system receives web site and ad search portal activity and click-stream data and stores it into an attached database 232. The ad search portal administrative system also interconnects to all other systems and databases (e.g., advertiser records database 238) so that overall ad search portal content and system administration, management and auditing can be accomplished.

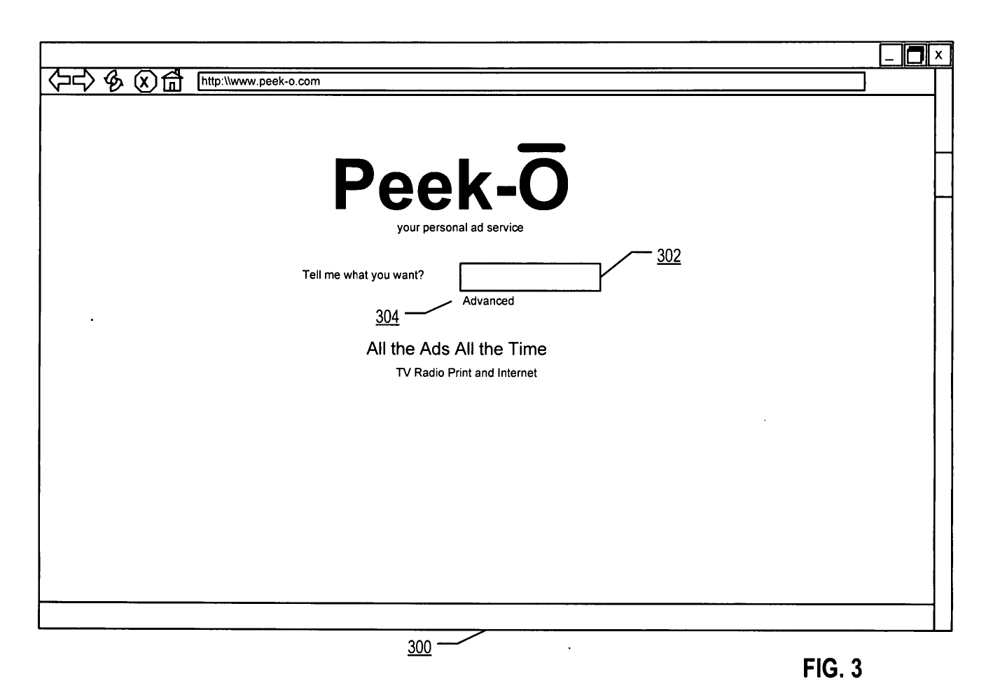

FIGS. 3 and 4 depict exemplary search home page (300) and search results pages (400) for an ad search portal web site in accordance with one embodiment of the present invention. These screen shots are meant to give a representative view of how these web pages may look in terms of content, layout and format but are not meant to limit in any manner the invention as many variations are conceivable.

The exemplary search home page 300, depicted in FIG. 3, includes a search entry field 302. Additionally, search home page 300 includes an advanced search option 304. By selecting advanced search option 304, the user may be able to select additional search functions.

The exemplary search results page 400, depicted in FIG. 4, includes information about the search data used to perform the search, such as search keywords 402. Additionally, search results page 400 includes information about advertisements from a plurality of media, including in this example, radio 404, print 406, television 408, and the Internet 410. The information about advertisements presented to the user may include text descriptions 414 or graphical representations, such as thumbnail 416, or post play image 418. Additionally, the search results page 400 may include a landing site link 412, allowing the user to go directly to a page controlled by the advertiser where additional product/service information or offers may be available.

Additionally, search results page 400 may include user selectable options to limit search results. For example local option 420 may allow the user to restrict search results displayed to advertisements targeted to the user's geographic location. In certain embodiments, if the user selects the local option 420, the user may be prompted to provide location information. In other embodiments, when the user selects local option 420, the user's location is automatically determined based on user preference data previously provided or location determination methods as previously described.

Global option 422 may allow the user to search all advertisement regardless of geographic targeting of such advertisements. For example, if the user has previously provided user preference data requesting that searches be limited to advertisements targeted to the user's geographic location, global option 422 may override this user preference for the present search. In another example, certain advertisers may elect to have their advertisements displayed only within a specified geographic region. In certain embodiments, global option 422 may allow users outside this geographic region to search even these advertisements.

Character option 424 may allow the user to search for advertisements containing a specified character or personality.

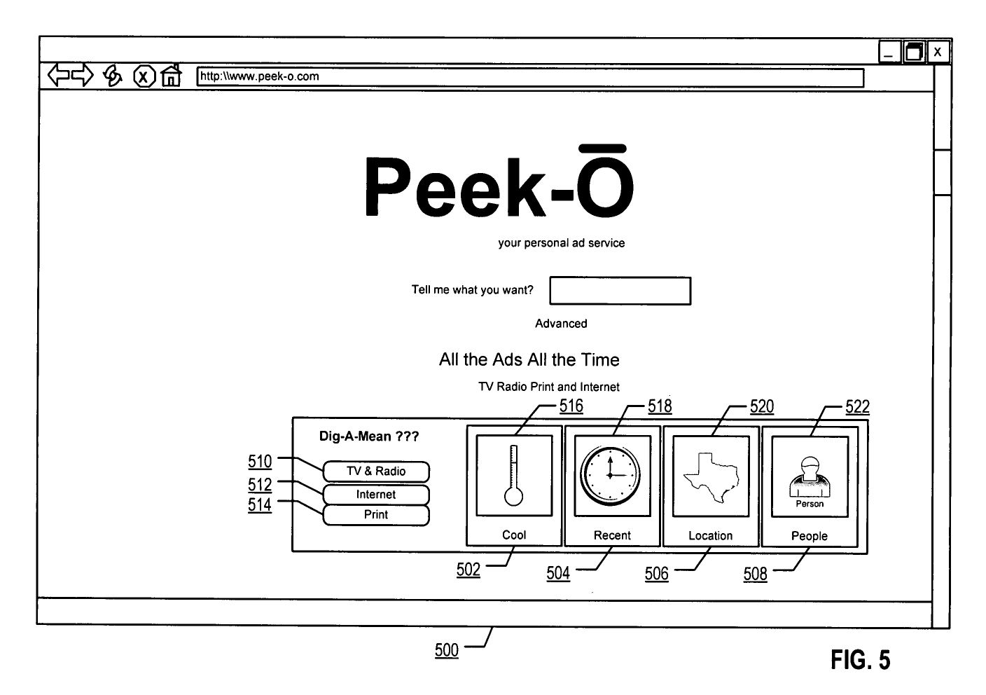

Systems and methods are described for keyword-based search sub-category option presentment in connection with web content searches. Web content is defined to include information, news, videos, images, pictures, text and/or advertising or any other information or data available on the World Wide Web (web) via the internet or on intranets. FIG. 5 depicts an exemplary embodiment of an advertising search options display. As shown in FIG. 5, according to one embodiment of the invention, end users can search using any web search engine for web content and upon entering their keyword selections, the systems and methods described herein may present a set of predefined or software generated sub-category keywords 502, 504, 506, 508 and/or associated images 516, 518, 520, 522 to the end user either on a new web page 500 within the search engine web site prior to generating the original keyword search results listing or directly on the search results listing web page based on the original keyword(s). The end user can select one of the subcategory keyword options to refine, focus, extend or expand their original keyword search process. Additionally, as depicted in FIG. 5, since methods and systems described generally relate to searching across multiple media formats, search options presented to the user may allow the user to restrict his or her search to a particular media format, such as Internet 512, or print 514, or to a combination of media formats, such as television and radio 510.

According to one embodiment, upon selection of a sub-category keyword, the search engine performs a search within the search results or an updated or new search containing the original keyword(s) and the sub-category keyword in the search string of the search engine returning updated, refined, focused and/or extended search results listings to the end user. In one embodiment, the sub-category keyword options are presented to the end user as hypertext links, buttons, hot items or some other form of identifiable image that results in a one-click user experience for launching the new or refined search. In this manner, more meaningful and relevant ways are provided to end users to narrow, extend, focus, expand or more closely define the web search process.

According to one embodiment, one objective of the sub-category keyword option presentment is to improve the end user's web search experience by offering, without prompting and as a natural part of the search process, common, related, or natural extensions to the end user specified keyword(s) that give the end user the option to select a subcategory keyword to narrow, refine, focus or expand the search process.

FIG. 6 is a flow diagram illustrating a cross media advertising search retrieval process 600 using sub-category search options in accordance with a particular illustrative embodiment. In the method of FIG. 6, a request is received 602 from the user to retrieve advertisements related to specified keywords or search data. Search options are created 604 and presented to the user. The search options suggest ways to refine, expand, focus or narrow the search initiated by the user. For example the search options may include sub-categories related to keywords received from the user.

Cross media advertising search results identified based on the search data and one or more cross media search results pages are created 606 to display the search results. The search results page or pages are served 608 for display to the user. Additionally or alternatively, one or more search options may be served for display to the user.

If search options are displayed to the user, and the user selects 610 one or more of the search options, the search option may be used to redefine or supplement the original search. For example, a sub-category keyword in the search option may be added 612 to the original keyword search string.

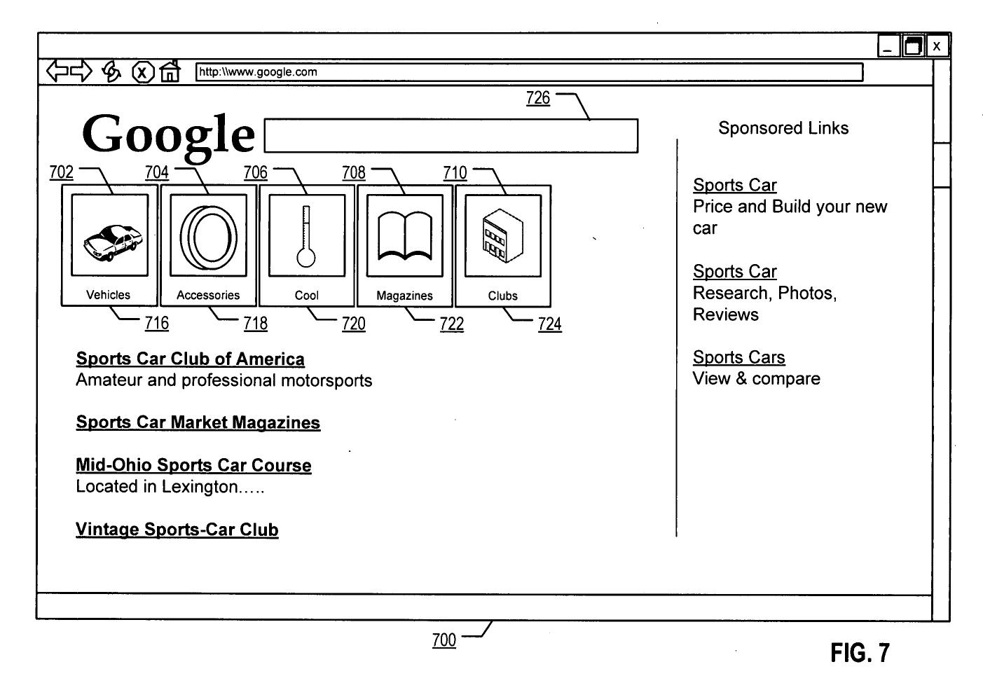

FIG. 7 illustrates an exemplary screen shot presenting a sub-category keyword option as part of the web search retrieval process in accordance with one embodiment of the present invention.

Various methods of identifying sub-category keywords are possible. For example, the sub-category keywords may be generated automatically by mining end user search behavior, such as click-through patterns, subsequent keyword refinement and/or sub-search behaviors. Sub-category keywords may be end user specific by employing user preference data described. According to one embodiment, sub-category keywords may be defined, either in a predefined manner by editors or by keyword sub-category association software system. For example, the sub-category keywords may be defined to closely relate to, be commonly affiliated with or share an affinity with the user-specified keyword entered into the search engine. The sub-category keywords may also be generic terms or topically specific to the end user defined keyword. The sub-category keywords may be defined so as to infer a more specific search string, to expand the search string or to make the search string more topically relevant or interesting to the end user based upon the original keyword specified by the end user.

For example, in one application or embodiment of the invention, the subcategory keywords may be generated automatically by mining end user search behavior and determining which subcategory keywords are most applicable or relevant to end users based on their search results click-through patterns and/or subsequent keyword refinement or sub-search behaviors. In this manner, a comprehensive listing of sub-category keywords could be defined for each possible end user keyword that could be entered and the search process could be improved by adding an application of the sub-category keyword option framework described herein to any web search engine.

FIG. 7 depicts an exemplary embodiment, in no way limiting the application of the invention. If the end user enters the keyword “sports car” into a search data entry field 726 of a web search engine 700, the sub-category keyword option process could present the end user with various subcategory keywords such as “cool” 720, “Vehicles” 716, “accessories” 718, “clubs” 724, “magazines” 722 just to name a subset of the possible subcategory keywords. In some embodiments, thumbnail icons 702, 704, 706, 708, 710 may be displayed in addition to, or instead of the subcategory keyword text. The number of subcategory keywords presented and the content, context and relevancy of the subcategory keyword selections is implementation specific and would typically be determined by the party applying the sub-category keyword option framework to a specific context.

What is claimed is:

1. A method of searching advertisements comprising:
displaying a search interface to a user;
receiving search data from the user, via the search interface, to request a search directed to advertising information; and
displaying search results related to the search directed to advertising information to the user, wherein the search results include information related to advertisements that are relevant to the received search data.

2. The method of claim 1, wherein the search results include advertisements from a plurality of different types of advertising media.

3. The method of claim 1, wherein the search results are displayed in order of relevance of the advertisements to the search data.

4. The method of claim 1, further comprising receiving a user selection of an advertisement from the search results, and displaying advertising content of the user selected advertisement.

5. The method of claim 4, further comprising displaying a landing site link to the user, wherein the landing site link includes information sufficient to direct a user interface to an advertiser landing site associated with the selected advertisement.

6. The method of claim 1, wherein the search data includes user preference settings.

7. The method of claim 1, wherein the search data includes user historical search information.

8. The method of claim 1, wherein the search results include at least one advertisement associated with a geographic location of the user.

9. An advertising search system comprising:
at least one memory including advertising content of a plurality of advertisements and advertising metadata related to the plurality of advertisements; and
logic in communication with the at least one memory operable to:
display a search interface to a user;
receive search data from the user, via the search interface, to request a search directed to advertising information; and
display search results related to the search directed to advertising information to the user, wherein the search results include information related to advertisements that are relevant to the received search data.

10. The system of claim 9, wherein the advertising information includes advertisements from a plurality of advertising media, and wherein the search results include advertisements from a plurality of different types of advertising media.

11. The system of claim 9, wherein the logic is further operable to display search results to the user in order of relevance of the advertisements to the search data.

12. The system of claim 9, wherein the logic is further operable to receive a user selection of an advertisement from the search results, and to display advertising content of a user selected advertisement.

13. The system of claim 12, wherein the logic is further operable to display a landing site link to the user, wherein the landing site link includes information sufficient to direct a user interface to an advertiser landing site associated with a selected advertisement.

14. The system of claim 9, wherein the search data includes user preference settings.

15. The system of claim 9, wherein the search data includes user historical search information.

16. The system of claim 9, wherein the logic is further operable to determine a user geographic location, and to include within the search results at least one advertisement associated with a geographic location of the user.

17. A method of searching advertisements comprising:
displaying an advertising search interface to a user;
receiving input from the user selecting an advertising category to search; and
displaying information related to at least one advertisement from the selected advertising category, the at least one advertisement displayed in a television format.

18. The method of claim 17, further comprising receiving a user selection related to the at least one advertisement displayed.

19. The method of claim 18, further comprising receiving a user selection of an advertisement from the displayed information related to at least one advertisement, and displaying the user selected advertisement in a television format.
